(19) United States
(12) Patent Application Publication
(10) Pub. No.: US 2026/0142979 A1
(43) Pub. Date: May 21, 2026

(54) ROLE-BASED REMOTE SESSION MANAGEMENT

(71) Applicant: Palo Alto Networks, Inc., Santa Clara, CA (US)

(72) Inventors: Oz Meir Gonen, Givvattayim (IL); Gal Moshe Shalev, Pardes Hanna-Karkur (IL); Liron Enkava, Givatayim (IL); Ofer Ben-Noon, Tel Aviv (IL)

(21) Appl. No.: 19/279,074

(22) Filed: Jul. 24, 2025

Related U.S. Application Data
(60) Provisional application No. 63/721,085, filed on Nov. 15, 2024.

(51) Int. Cl. H04L 9/40

(52) U.S. Cl. CPC H04L 63/105; H04L 63/166

(57) ABSTRACT

A remote session service manages role-based remote session access across an organization. Based on receiving, from a requestor endpoint, a request for a remote session with a target endpoint, the remote session service evaluates a role-based access policy to determine if the remote session is allowed. If the remote session is allowed, the remote session service uses Interactive Connectivity Establishment to establish a peer-to-peer (P2P) connection between the requestor endpoint and the target endpoint. The requestor and target endpoints then communicate real-time media and peripheral input events over the P2P connection to enable remote session sharing, remote session control, session auditing, summary, and behavioral analysis, role-based content blocking/filtering, etc.

### BACKGROUND

The disclosure generally relates to electronic communication techniques (e.g., CPC class H04) and arrangements for maintenance, administration, or management of packet switching networks (e.g., CPC subclass H04L 41/00).

Role-based access control (RBAC) is an approach to security, typically within an organization and applied to actions performed by users associated with that organization and via networks internal and external to the organization. RBAC assigns each user a role within an organization, and each role has associated privileges that determine the information and resources that a user is allowed to access and what types of actions a user is allowed to perform for accessible resources/information. Policies for RBAC comprise rules that determine access of a user to a particular action on a resource or other type of information according to that user's role.

### BRIEF DESCRIPTION OF THE DRAWINGS

Embodiments of the disclosure may be better understood by referencing the accompanying drawings.

FIG. 1 is a schematic diagram of an example system for establishing a remote peer-to-peer (P2P) connection between a requestor endpoint and a target endpoint using respective local services and a remote session service managing RBAC.

FIG. 2 is a flowchart of example operations for establishing a remote session between requestor and target endpoints.

FIG. 3 is a flowchart of example operations for filtering content displayed at a target endpoint in a remote session using role-based access policies.

FIG. 4 is a flowchart of example operations for monitoring and/or auditing user behavior in a remote session.

FIG. 5 is a flowchart of example operations for activating remote control for a requestor endpoint in a remote session with a target endpoint.

FIG. 6 depicts an example computer system with a remote session service and local services for establishing P2P connections using role-based access policies.

### DESCRIPTION

The description that follows includes example systems, methods, techniques, and program flows to aid in understanding the disclosure and not to limit claim scope.

Well-known instruction instances, protocols, structures, and techniques have not been shown in detail for conciseness.

### Overview

Existing technologies for remote access control of geographically or otherwise distributed network devices (e.g., requiring an external network connection) often require overly excessive permissions, require setup with external, sometimes third-party applications, and introduce security exposures. For instance, sensitive data could inadvertently be shared during a remote session, an attacker could gain unauthorized access to a remote session or hijack a communication channel for a session, and endpoints in a remote session could experience latency or bandwidth constraints. Moreover, these technologies lack granular access control that allows control of allowed remote sessions and actions within remote sessions using RBAC. The present disclosure proposes local services running locally on endpoint devices paired with a remote session service for remote session management to reduce additional setup/friction when establishing and managing remote sessions. When a requestor endpoint (e.g., an endpoint device of an administrator of an organization) requests a remote session with a target endpoint (e.g., an endpoint device of a user of the organization), the requestor endpoint communicates the request to a remote session service managing RBAC for the organization. The remote session service determines whether a remote session is allowed between the requestor and target endpoints according to a role-based access policy for the organization. If the remote session is allowed, the remote session service exchanges session description protocol (SDP) messages between the requestor and target endpoints, then negotiates respective IP address and port pairs with Interactive Connectivity Establishment (ICE). Once a direct P2P connection has been established between the requestor and target endpoints, the remote session proceeds by the target endpoint (i.e. a local service running on the target endpoint) communicating peripheral input events (i.e., keyboard events, mouse events) and real-time media to the requestor endpoint, and the requestor endpoint (i.e., a local service running on the requestor endpoint) simulating the remote session at the web browser using the peripheral input events.

The aforementioned configuration allows for establishment of low latency, high bandwidth remote sessions via the remote session service. The remote session service maintains endpoint roles that determine whether the requestor endpoint has a role with sufficient permissions to establish remote sessions with the target endpoint. These permissions are granular, so that in some instances with a high level of permissions, the requestor endpoint can establish a remote session with the target endpoint without the target endpoint's knowledge, whereas with lower permissions the target endpoint may be prompted before allowing the remote session. The resulting P2P connection uses the Stream Control Transmission Protocol (SCTP) as an application layer protocol running over a Datagram Transport Layer Security (DTLS) connection, reducing security exposures via unauthorized access and session hijacking. This approach offers additional features such as session logging for auditing, monitoring session behavior for abnormalities using machine learning, allowing remote control by the requestor endpoint also using peripheral input events, control of access by the target endpoint to specific resources based on its role, and blocking webpages, tabs, or otherwise filtering content communicated from the target endpoint in the P2P connection for data loss prevention (DLP). Overall, the present disclosure provides an efficient alternative to traditional Virtual Desktop Infrastructure solutions, allows minimal friction while maintaining enterprise-level security standards, has controls like automatic approval for known devices, and facilitates use cases such as customer support, collaboration, remote access, privileged access, and training scenarios. The resulting service is efficient, seamless, and secure.

### Example Illustrations

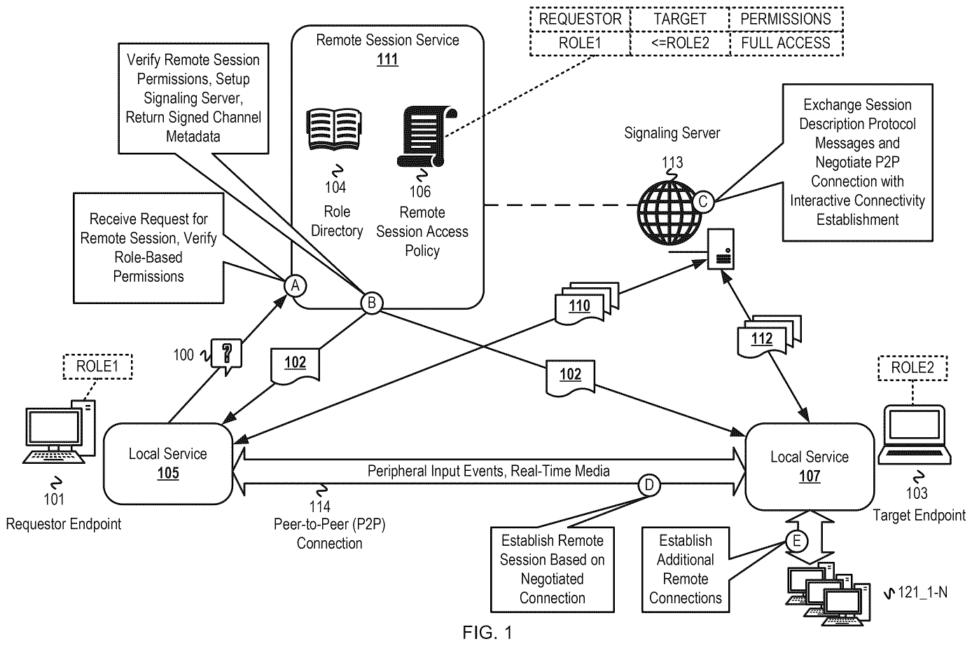

FIG. 1 is a schematic diagram of an example system for establishing a remote P2P connection between a requestor endpoint and a target endpoint using respective local services and a remote session service managing RBAC. A requestor endpoint 101 and a target endpoint 103 are running local services 105, 107, respectively, that are paired with a remote session service 111 to establish and manage remote sessions between endpoints within an organization (not depicted) according to respective roles of users of those endpoints. Based on receiving a request 100 from the local service 105 for establishing a remote session with the target endpoint 103, the remote session service 111 determines whether a role of the requestor endpoint 101 has sufficient access permissions for establishing a session with a role of the target endpoint 103. If sufficient permissions are established, the remote session service 111 sets up a signaling server 113 and communicates signed channel metadata 102 to the local services 105, 107. The local services 105, 107 then exchange SDP messages to negotiate a P2P connection 114 via the signaling server 113. Once the P2P connection 114 is established, the local service 105 simulates a remote session with the local service 107 by receiving real-time media and peripheral input events from the local service 107 via the P2P connection 114.

FIG. 1 is annotated with a series of letters A-E. Each stage represents one or more operations. Although these stages are ordered for this example, the stages illustrate one example to aid in understanding this disclosure and should not be used to limit the claims. Subject matter falling within the scope of the claims can vary from what is illustrated.

At stage A, a user of the requestor endpoint 101 inputs the request 100 to an interface of the local service 105, and the local service 105 communicates the request 100 to the remote session service 111. The local service 105 (and, similarly, the local service 107) can comprise a SaaS application, an integrated tool such as a tool integrated in a custom browser, etc. and can be set up with increased privileges such as kernel level privileges. The increased privileges will allow the local services 105, 107 to simulate remote sessions without having to request execution of certain processes from respective operating systems, for instance to perform operating system command injection, allowing for seamless remote sessions. Increased privileges will allow the local services 105, 107 to simulate peripheral input events on the requestor endpoint 101 and the target endpoint 103, respectively, allowing for actions such as running Secure Shell (SSH) commands, modifying core functions, and performing other system-level operations. The local services 105, 107 can comprise a custom web browser, a plugin for a web browser, and/or can be installed as independent processes that continue running on the respective operating systems even after a web browser is closed. The remote session service 111 is a service that manages remote sessions across the organization, for instance a service running in the cloud accessible by the local services 105, 107 via an application programming interface (API). The request 100 indicates an identifier of the requestor endpoint 101 and the target endpoint 103 and, in some embodiments, an identifier of a user logged into the requestor endpoint 101.

At stage B, the remote session service 111 verifies permissions for establishing a remote session between the requestor endpoint 101 and the target endpoint 103. The remote session service 111 performs a lookup of identifiers of the endpoints 101, 103 and/or identifiers of users logged in at the endpoints 101, 103 to determine respective roles. The remote session service 111 can track users logged in at local services on endpoint devices across an organization to identify users of the endpoints 101, 103. In this example, the requestor endpoint 101 and/or user has a role “ROLE1” and the target endpoint 103 and/or user has a role “ROLE2”. The remote session service 111 then checks the retrieved roles to determine whether the remote session is allowed according to a remote session access policy 106. In the depicted example, the remote session access policy indicates that a requestor with role “ROLE1” has full access permissions to a target with role less than or equal to “ROLE2”. In this example, the less than or equal logic indicates any roles have equal or lower permissions to role “ROLE2”. Full access means that the requestor endpoint 101 may establish a P2P connection for remote viewing of activity on the target endpoint 103 with or without approval from the target endpoint 103. In other examples, permissions may indicate that establishing a remote session is blocked or there is partial access, i.e., the remote session service 111 must first request approval from the target endpoint 103 prior to establishing the remote session.

As an additional layer of security, the remote session service 111 can implement two-factor authentication (2FA) prior to establishment of a remote session. The remote session service 111 can authenticate the remote session via a 2FA method set up by a user of the requestor endpoint 101 and/or a user of the target endpoint 103. Determining whether to use 2FA when verifying permissions of the remote session can be based on the remote session access policy 106 and roles of the endpoints 101, 103.

Roles of endpoints of the organization managed by the remote session access policy 106 can depend on sensitivity of data exposure for respective endpoints and/or security zones where those endpoints are deployed, access levels/job titles of corresponding users (e.g., administrators, senior or junior developers), branch locations of the organization where the users are located, etc. The remote session access policy can apply logic not only to roles but also any of this metadata to determine whether a remote session is allowed. For instance, an endpoint at a branch location that stores highly sensitive data may be blocked from remote sessions with endpoints at any other branch locations, regardless of corresponding roles. Organizational roles can be separated from external roles, and internal (organizational) roles can automatically approve remote session requests.

Subsequent to verifying that a remote session between the requestor endpoint 101 and the target endpoint 103 is allowed, the remote session service 111 sets up the signaling server 113 and generates and signs channel metadata 102 that the remote session service 111 then communicates to the requestor endpoint 101 and the target endpoint 103. As an illustrative example, the remote session service 111 can set up the signaling server and determine the channel metadata 102 using the Amazon® Kinesis Video Streams (KVS) service with Web Real-Time Communication (WebRTC). For this example, the signaling server 113 can be a secure WebSocket server set up via an API of the Amazon KVS service. The channel metadata 102 can include a uniform resource identifier (URI)/port of the signaling server 113, can indicate whether Session Traversal Utilities for Network Address Translation (NAT) (STUN) and/or Traversal Using Relays around NAT (TURN) will be used during ICE, can indicate URIs of any additional servers that will be used for ICE (not depicted), etc. The remote session service 111 additionally signs the channel metadata 102 with a digital signature. This digital signature verifies authenticity of the channel metadata 102 to reduce security risks from man-in-the-middle attacks.

At stage C, the local services 105, 107 exchange SDP messages and responses 110, 112, respectively, via the signaling server 113 to negotiate a P2P connection with ICE. As an example, the local service 105 communicates an SDP offer including supported data types (e.g., audio data, video data) for the P2P connection 114, ICE candidates in the form of candidate Internet Protocol (IP) address/port pairs through which the local service 107 can attempt to connect to the local service 105, etc. The local service 105 can determine the candidate IP address/port pairs using STUN and/or TURN servers indicated for ICE in the channel metadata 102. The local service 105 communicates the SDP offer message to the local service 107 via the signaling server 113 and the local service 107 performs a similar process via the STUN and/or TURN servers to generate and SDP answer message. The signaling server 113 then negotiates the P2P connection 114 via connectivity checks between the local services 105, 107 according to the SDP offer message and the SDP answer message. If the connectivity checks fail (e.g., when a STUN server is unable to initiate a connection), the local services 105, 107 may instead establish a connection via relay servers using STUN requests to TURN servers.

At stage D, the local services 105, 107 establish the P2P connection 114. The P2P connection 114 is configured so that, initially, the local service 105 simulates actions performed on the local service 107 (as indicated by the request 100), so that a user of the requestor endpoint 101 can view the target endpoint 103 as part of the remote session. This is facilitated by the local service 107 communicating real-time media (e.g., audio data, video data) that allows for rendering a view of the remote session on the local service, as well as peripheral input events that allow the local service 105 to simulate user actions performed at the target endpoint 103 during the remote session. Because the local services 105, 107 are set up to have increased privileges on the requestor endpoint 101 and the target endpoint 103, respectively, they are able to enable additional features as part of the remote session via the P2P connection 114. These features include allowing the requestor endpoint 101 to take over the remote session and inject operating system commands, selectively blocking/filtering content accessed by the target endpoint 103 and/or content communicated via the P2P connection, monitoring/auditing remote sessions using session logs and/or real-time session analysis with artificial intelligence, etc. These features are described in greater detail in the subsequent Figures.

Returning to the above example where the signaling server 113 is set up by the remote session service 111 via the Amazon KVS service with WebRTC, APIs involved in the foregoing operations include the RTCPeerConnection API for establishing the P2P connection 114, the RTCDataChannel API for communicating peripheral input events and real-time media via the P2P connection 114, the RTCTrackEvent API for communicating when a new media track (e.g., audio/video track) is received by one of the local services 105, 107, the RTCIceCandidate and RTCSessionDescription APIs for negotiating the P2P connection 114 via the signaling server 113, and additional media playback/capture, desktop capture, and/or permissions APIs for corresponding web browsers when the local services 105, 107 are implemented as part of web browsers. Establishing the P2P connection 114 and a fallback connection (e.g., via a relay server) can occur using the Transmission Control Protocol (TCP), while the P2P connection 114 can use SCTP as an application layer protocol over a DTLS connection in the transport layer. The P2P connection 114 can support file transmission with the Secure Copy Protocol (SCP).

At stage E, additional requestor endpoints 121_1-N establish remote connections with the target endpoint 103 via respective P2P connections as part of the remote session between the requestor endpoint 101 and the target endpoint 103. The target endpoint 103 can stream identical traffic along each parallel P2P connection. In some embodiments, a separate server or endpoint can manage traffic via the P2P connection 114 and P2P connections for each of the additional requestor endpoints 121 1-N. Each of the requestor endpoints 121_1-N has a separate local service that enforces access of content along the respective P2P connections a determines whether a requestor endpoint is able to establish a remote session with or without permission from the target endpoint 103 and whether a requestor endpoint is able to remotely control the remote session. The local service 107 at the target endpoint 103 can be configured so that only a single requestor endpoint of the endpoints 101, 121_1-N is able to have remote control at a given time. P2P connections for the endpoints 121_1-N are also established with the remote session service 111, albeit with possibly a different signaling server.

FIG. 1 depicts RBAC as being enforced by the remote session service prior to establishing the P2P connection 114 and subsequently enforced by the local services 105, 107 during the P2P connection 114, for instance to control what resources are accessible by the target endpoint 103, what actions the requestor endpoint 101 is allowed to perform remotely on the target endpoint 103, whether the requestor endpoint 101 can establish a connection with the target endpoint 103 without approval, etc. RBAC can alternatively be performed by one or more firewalls (e.g., in the cloud or running natively on the endpoints 101, 103) monitoring network traffic for the requestor endpoint 101 and the target endpoint 103, including traffic communicated along the P2P connection 114 and traffic from the target endpoint 103 browsing the Internet that is partially communicated along the P2P connection 114. For instance, the one or more firewalls can use context-aware security policies by combining identity awareness, user-based policies, and dynamic policy enforcement. As an illustrative example, a firewall can monitor the target endpoint 103 browsing the Internet while in a remote session with the requestor endpoint 101 and can block resources that target endpoint 103 is not authorized to access (e.g., according to a user-based security policy applied to a user of the target endpoint 103). Additionally, another firewall can monitor traffic in the P2P connection and can remove or block any traffic comprising potentially sensitive data for DLP.

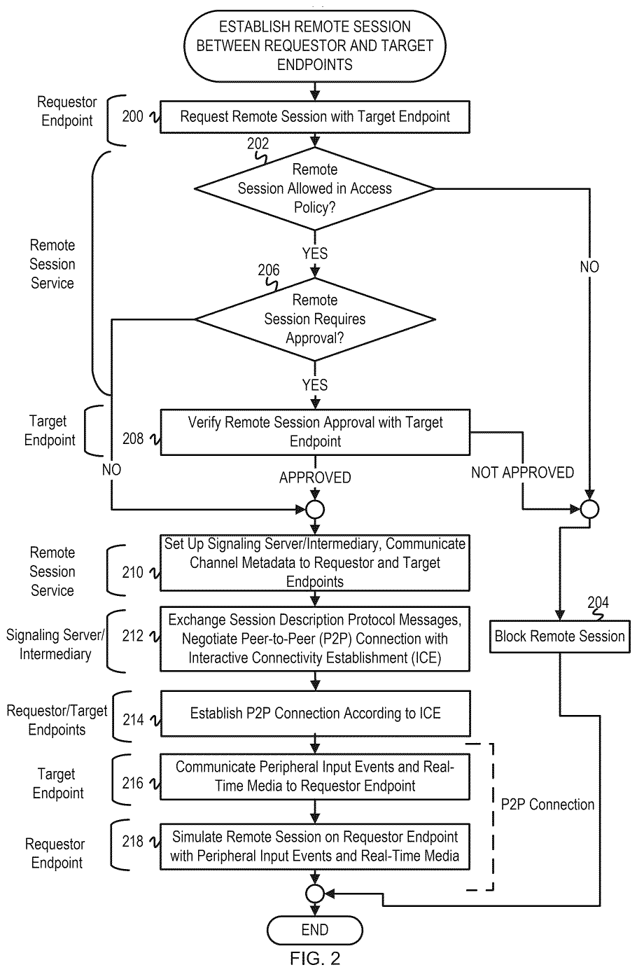

FIGS. 2-5 are flowcharts of example operations. The example operations are described with reference to a requestor endpoint, a target endpoint, a remote session service, and a signaling server for consistency with FIG. 1 and/or ease of understanding. Operations described as being performed by a requestor/target endpoint can be performed by a local service running on the respective endpoint. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for establishing a remote session between requestor and target endpoints. At block 201, the requestor endpoint requests a remote session with the target endpoint. The request indicates an identifier of the requestor endpoint and the target endpoint and/or identifiers of users of the requestor endpoint and target endpoint. The requestor endpoint communicates the request to a remote session service, e.g., a cloud-based service managing access policies for remote sessions across an organization.

At block 202, the remote session service determines whether the remote session is allowed based on a role-based access policy. The remote session service retrieves roles of the requestor endpoint and the target endpoint based on user and/or endpoint identifiers communicated in the request. The remote session service can also maintain a list of users logged into each endpoint and can retrieve user identifiers and corresponding roles based on users logged into the requestor and target endpoints according to the list. The access policy can comprise rules for various roles and corresponding access permissions. For instance, a rule can indicate a range of requestor and target roles, and whether each pair of requestor and target endpoints having roles within the respective ranges is allowed for establishing a remote session. If a remote session between the requestor endpoint and the target endpoint is allowed according to the access policy, operational flow proceeds to block 206. Otherwise, operational flow proceeds to block 204.

At block 204, the remote session service blocks the remote session, for instance by communicating an alert to the requestor endpoint indicating that the remote session was blocked and a reason for the blocking (e.g., that the requestor endpoint role has insufficient access privileges, that the target endpoint has an external role to the organization, etc.). Reasons for blocking can be indicated in the access policy. The operational flow in FIG. 2 terminates.

At block 206, the remote session service determines whether the remote session requires approval from the target endpoint. Whether the remote session requires approval from the target endpoint can also be indicated in the access policy. If the remote session requires approval, operational flow proceeds to block 208. Otherwise, operational flow proceeds to block 210.

At block 208, the remote session service requests approval for the remote session from the target endpoint. For instance, the request can comprise an alert indicating that a remote session has been requested and an identifier of the requestor endpoint, an identifier of the user of the requestor endpoint, an indication of the role of the user/requestor endpoint, etc. If the target endpoint approves the remote session (e.g., by clicking a graphical user interface (GUI) element corresponding to approval of the remote session), operational flow proceeds to block 210. Otherwise, if the target endpoint does not approve the remote session, operational flow proceeds to block 204 and the remote session is blocked.

At block 210, the remote session service sets up a signaling server/intermediary and communicates channel metadata to the requestor and target endpoints. For instance, the remote session service can set up the signaling server/intermediary as a WebSocket server via the Amazon KVS API. The remote session service can additionally set up STUN and TURN servers to facilitate negotiating a P2P connection between the requestor and target endpoints with ICE. The remote session service generates channel metadata that at least indicates URIs/ports of any servers to be used for ICE and signs the channel metadata with a digital signature to verify authenticity at the requestor and target endpoints.

At block 212, the signaling server/intermediary exchanges SDP messages to negotiate a P2P connection between the requestor and target endpoints with ICE. First, the requestor endpoint generates an SDP offer message indicating supported media types/formats (e.g., video, audio, etc.) and candidate IP address/port pairs. The requestor endpoint can determine the candidate IP address/port pairs using the STUN and/or TURN servers indicated in the channel metadata. The requestor communicates the SDP offer message to the signaling server/intermediary and the signaling server/intermediary forwards the SDP offer to the target endpoint. The target endpoint generates an SDP answer message similarly and communicates the SDP answer message to the signaling server. The signaling server then negotiates a P2P connection between the requestor and target endpoints using the candidate IP address/port pairs indicated in the SDP offer and answer messages. If no connection is able to be negotiated, the signaling server may set up or instantiate a relay server to serve the P2P connection.

At block 214, the requestor and target endpoints establish a P2P connection according to the ICE. For instance, the P2P connection can be established using the WebRTC RTCDataChannel API using SCTP as an application layer protocol and DTLS as a transport layer protocol for secure communications over the P2P connection, according to respective candidate IP address/port pairs for the requestor and target endpoints determined during ICE.

In some embodiments, negotiations may fail when establishing a P2P connection when the network rules are strict. In this case, instead of establishing a P2P connection, the requestor and target endpoints establish a connection via a relay server, e.g., a TURN server indicated in the signed channel metadata communicated by the remote session service.

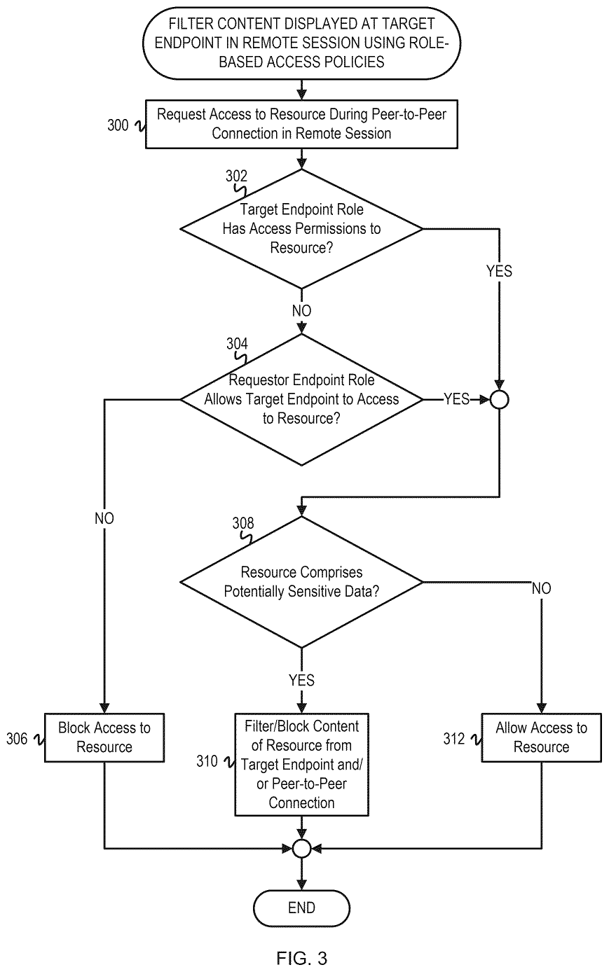

Blocks 216 and 218 are indicated in FIG. 2 as occurring as part of the P2P connection. The operations at blocks 216 and 218 can occur in real time as data is communicated over the P2P connection and need not occur sequentially as indicated in FIG. 2. Additional operations that may be performed over the P2P connection, once established, are depicted in FIGS. 3-5.

At block 216, the target endpoint communicates peripheral input events (e.g., keyboard and mouse click events) and real-time media to the requestor endpoint. Depending on the level of access enabled by the P2P connection, additional data such as process events, files etc. can be communicated from the target endpoint to the requestor endpoint.

At block 218, the requestor endpoint simulates the remote session in its operating system using the peripheral input events and real-time media communicated from the target endpoint. The local service running on the requestor endpoint has privileges to inject operating system commands as part of the simulation. The operations at blocks 216 and 218 occur until the remote session is terminated. The requestor and/or the target endpoint can have controls to manually terminate the remote session, for instance via a GUI. The subsequent operations described in reference to FIGS. 3-5 assume that a P2P connection has been established between the requestor and the target endpoint.

FIG. 3 is a flowchart of example operations for filtering content displayed at a target endpoint in a remote session using role-based access policies. At block 300, the target endpoint requests access to a resource during a P2P connection with a requestor resource. The resource can comprise a resource associated with an organization (e.g., a database) requested via an internal or external network, a website requested by the target endpoint via the Internet, etc.

At block 302, a local service executing on the target endpoint determines whether a role of the target endpoint has access permissions to the resource. The access permissions can be determined according to a role-based access policy of organizational resources, a Uniform Resource Locator (URL) filtering component/list that blocks access to potentially malicious websites, etc. Resources of the organization can have privilege levels that only allow access by certain roles in the organization. These access levels can be location dependent, for instance certain resources such as databases may only allow access via internal networks. If the target endpoint has access permissions to the resource, operational flow proceeds to block 308. Otherwise, operational flow proceeds to block 304.

At block 304, the local service determines whether a role of the requestor endpoint allows the target endpoint to access the resource. Certain administrative roles or other supervisory roles of the requestor endpoint may allow a target endpoint to access the resource during a remote session between the requestor and target endpoints (e.g., as a part of training or supervision), whereas that target endpoint may otherwise not be allowed access to the resource. If the role of the requestor endpoint allows the target endpoint to access the resource, operational flow proceeds to block 308. Otherwise, operational flow proceeds to block 306.

At block 306, the local service blocks the target endpoint from accessing the resource. For instance, the local service can block any associated HyperText Transfer Protocol (HTTP) requests to the resource, can display an alert indicating that access to the resource was blocked and a reason for the blocking, etc. Operational flow in FIG. 3 then terminates.

At block 308, the local service determines whether the resource comprises potentially sensitive data. For instance, the local service can determine whether a URL or URI of the resource is on a list of resources that comprise potentially sensitive data. Moreover, the local service can perform DLP techniques such as named entity recognition to identify potentially sensitive data. If the resource comprises potentially sensitive data, operational flow proceeds to block 310. Otherwise, operational flow proceeds to block 312.

At block 310, the local service filters and/or blocks content of the resource from the target endpoint and/or from the P2P connection between the target and requestor endpoints. For instance, when a resource comprises potentially sensitive data of the user of the target endpoint (e.g., email addresses, passwords, credit card numbers, etc.) that are displayed at the target endpoint, this potentially sensitive data can be displayed on the target endpoint and removed/filtered from real-time media communicated from the target endpoint to the requestor endpoint. Alternatively, when a webpage or other resource/related content communicated to the target endpoint comprises potentially sensitive data, the potentially sensitive can be removed/blocked prior to being rendered at the target endpoint (and as such will also not be communicated via real-time media to the requestor endpoint). The operational flow in FIG. 3 terminates.

At block 312, the local service allows access to the resource. The P2P connection then proceeds as normal.

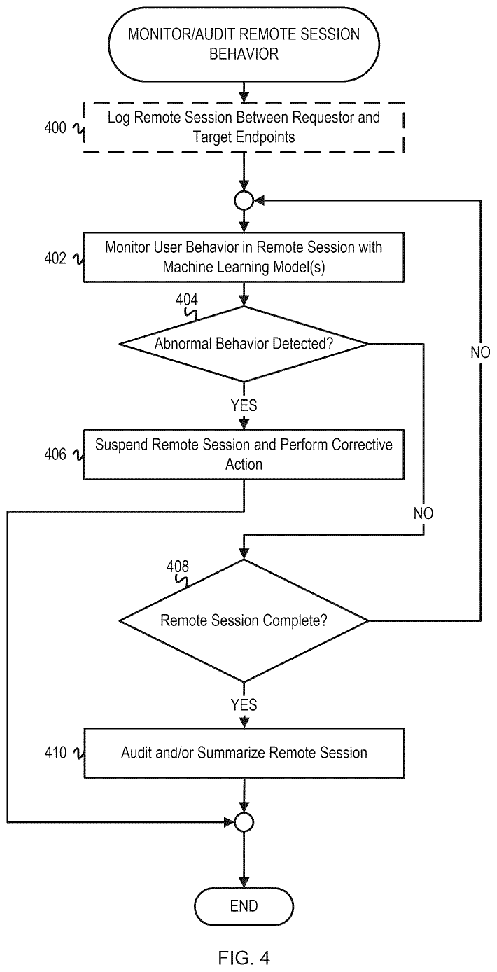

FIG. 4 is a flowchart of example operations for monitoring and/or auditing user behavior in a remote session. At block 400, a requestor endpoint and/or target endpoint logs a remote session between the requestor endpoint and the target endpoint. In some embodiments, only endpoints corresponding to a role with sufficient access rights are allowed to log remote sessions. Logging of sessions can occur locally at the requestor endpoint and/or target endpoint, or logs can be stored in the cloud. Block 400 is depicted with a dashed outline to indicate that logging of remote sessions is ongoing for each remote session established between the requestor/target endpoints and independent of the remaining operations in FIG. 4 so long as the remote session remains active. Although either of the requestor and target endpoints can perform monitoring and auditing, the remaining operations in FIG. 4 are described as being performed by the requestor endpoint for convenience.

At block 402, the requestor endpoint monitors user behavior in the remote session using a machine learning model(s). The user behavior can be monitored using packet capture files of packets communicated during the P2P connection. The machine learning model(s) can comprise a preprocessing component that generates feature values from the packet capture files (or other data representation of communications between the requestor/target endpoints during the P2P session), and the machine learning model(s) classifies the generated feature values as malicious/benign or normal/abnormal. The machine learning model is trained on feature values generated from known malicious/benign or normal/abnormal P2P connections. Example machine learning models include neural network classifiers, support vector machines, random forest classifiers, etc.

At block 404, the requestor endpoint determines if the machine learning model(s) detected abnormal (or malicious) behavior according to output of the machine learning model(s) from inputting the feature values. If the machine learning model(s) detected abnormal (or malicious) behavior, operational flow proceeds to block 406. Otherwise, operational flow proceeds to block 408. In embodiments where there are multiple machine learning models, abnormal/malicious behavior can be detected as a consensus verdict among verdicts output by each machine learning model.

At block 406, the requestor endpoint suspends the remote session and performs corrective action. Corrective action can comprise generating alerts to the requestor/target endpoints, forwarding the session logs to additional cybersecurity components for further analysis, etc. Based on the outcome of the corrective action, the remote session may be subsequently blocked or allowed to continue. The operational flow in FIG. 4 terminates.

At block 408, the requestor endpoint determines if the remote session is complete. For instance, when the remote session is established with SCTP as the application layer protocol, the requestor endpoint can determine that a shutdown message has been communicated as part of the remote session to initiate session shutdown. If the remote session is complete, operational flow proceeds to block 410. Otherwise, operational flow returns to block 402.

At block 410, the requestor endpoint audits and/or summarizes the remote session. For instance, the requestor can audit the remote session by performing post-incident analysis of any actions (e.g., process events, keyboard/mouse click events, requested resources, etc.) according to statistics indicating normal occurrence of these actions. The requestor endpoint can summarize the session by extracting content from the logs (e.g., text content, image content, etc. displayed on endpoints as part of the remote session) and requesting a large language model to summarize the remote session. Results from the session summary and/or audit can subsequently be displayed on the requestor endpoint and/or stored in a database for future analysis.

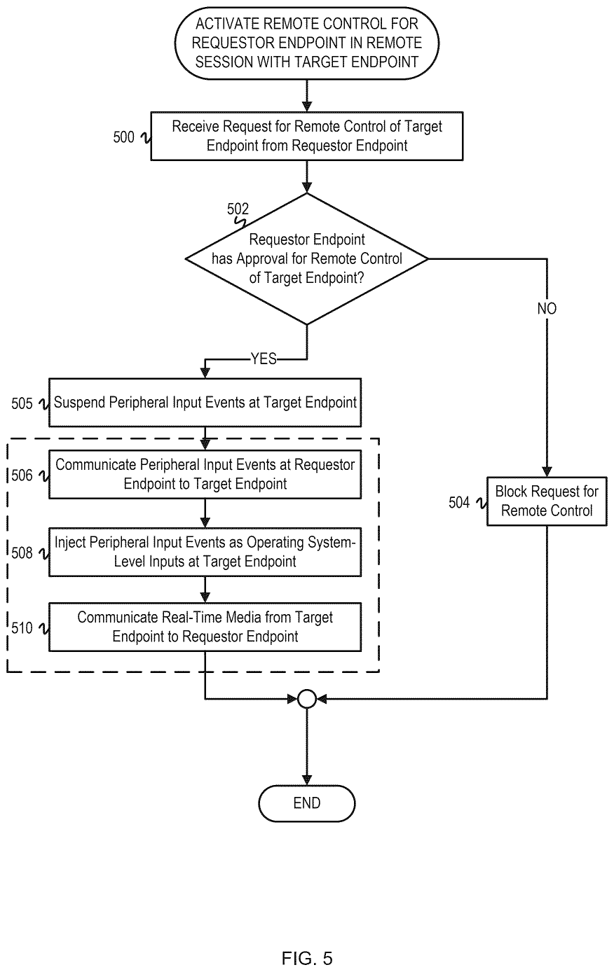

FIG. 5 is a flowchart of example operations for activating remote control for the requestor endpoint in the remote session with the target endpoint. The operations at blocks 506, 508, and 510 can occur in parallel as part of the P2P connection for the remote session with the requestor being in remote control, as indicated by the dashed outline around these blocks in FIG. 5.

At block 500, a target endpoint receives a request from a requestor endpoint for remote control of the target endpoint. For instance, the requestor endpoint can instantiate the request via a GUI element of a local service running on the requestor endpoint managing remote sessions.

At block 502, the target endpoint determines whether the requestor endpoint has approval for remote control. Approval for remote control is according to a role-based access policy. The target endpoint, during establishment of a P2P connection with the requestor endpoint as part of the remote session, received a trusted indication of the role of the requestor, for instance via a remote session service managing the role-based access policy across endpoints of the organization. In some embodiments, when the role of the requestor endpoint does not have sufficient privileges for automatic approval of remote control, the target endpoint can query a user of the remote session at the target endpoint to obtain approval. If the requestor endpoint has approval for remote control of the target endpoint according to its role, operational flow proceeds to block 505. Otherwise, operational flow proceeds to block 504.

At block 504, the target endpoint blocks the request for remote control. The operational flow in FIG. 5 then terminates.

At block 505, the target endpoint suspends peripheral input events from being executed by the operating system. For instance, a local service with high level privileges (e.g., kernel level privileges) executing on the target endpoint can suspend peripheral input events (e.g., mouse clicks, keyboard clicks) from peripheral devices physically coupled to the target endpoint.

At block 506, the requestor endpoint communicates peripheral input events from peripheral devices physically coupled to the target endpoint.

At block 508 the target endpoint injects the peripheral input events received by the requestor endpoint as operating system-level inputs. For instance, the local service on the target endpoint can use operating system command injection based on its elevated privilege to execute the peripheral input events. This enables actions such as running Secure Shell commands, modifying core functions, and performing other system-level operations efficiently. According to a policy maintained at the requestor and/or target endpoints, there may be granular control over actions that are allowed to be performed via injected peripheral input events. For instance, the requestor endpoint may only be able to control certain browser tabs, certain applications, certain data types, etc. on the target endpoint.

At block 510, the target endpoint communicates real-time media to the requestor endpoint via the P2P connection. Remote control of the target endpoint occurs according to the operations described in reference to blocks 506, 508, and 510 until either of the target or requestor endpoints terminates the remote control (which may or may not be allowed based on their respective roles) or the remote session terminates.

In some embodiments, the requestor endpoint may be blocked from performing certain actions corresponding to the peripheral input events according to an access policy. For instance, the requestor endpoint may be blocked from performing actions on certain native applications on the target endpoint, from accessing certain resources or files having sensitive user data, from requesting certain tabs of a web browser or certain websites, etc. A user of the target endpoint can have the option to specify websites or data categories that are allowed to be shared during remote sessions, which minimizes data exposure and allows for continuous connectivity between requestor and target endpoints. Accordingly, local services running on the target endpoint and/or requestor endpoint may block peripheral input events and/or operating system command injection at block 510 when such a blocked action is about to occur.

### Variations

Any of the foregoing operations related to remote sessions can be performed with custom web browser, tools/plugins built into existing web browser, separate tool configured to execute as an independent process without web browsers (allowing for seamless establishment of remote sessions), etc. As such, a “remote” session can alternatively be a “cobrowsing” or “co-browsing” session occurring solely in web browsers at requestor and target endpoints. Nonetheless, a tool/plugin/application enabling the cobrowsing/co-browsing sessions may operate as an independent process even when a corresponding web browser is terminated, so that a cobrowsing/co-browsing session need not be reestablished when the web browser is re-instantiated.

Although described as peripheral input events for peripheral devices physically coupled with endpoint devices, peripheral input events can comprise events occurring at natively integrated components with which a user interacts, for instance laptop mouses, keyboards, trackpads, mobile phone screens, etc.

The foregoing description mentions establishing a P2P connection between a requestor endpoint and a target endpoint. More generally, the P2P connection can comprise any connection between endpoints. For instance, when negotiating a P2P connection fails during ICE (e.g., when the SDP offer and SDP answer messages do not have compatible IP address/port pairs for establishing a P2P connection), the connection can instead comprise a connection via a relay server. Additionally, the connection can comprise multiple parallel connections between multiple requestor endpoints and a target endpoint that each mimic the same remote session. Any of the requestor endpoints can request and obtain control of the remote session while the session is streamed to the other requestor endpoints. Each local service running on a requestor endpoint can enforce distinct access policies according to respective roles of the request endpoints as part of the remote session. Requestor endpoints may have visibility across an organization as to which target endpoints are available for remote sessions (e.g., via a graphical user interface of a local service) prior to requesting a remote session, and the visibility can be displayed based on target endpoints that each requestor endpoint is allowed to access.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 506, 508, and 510 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

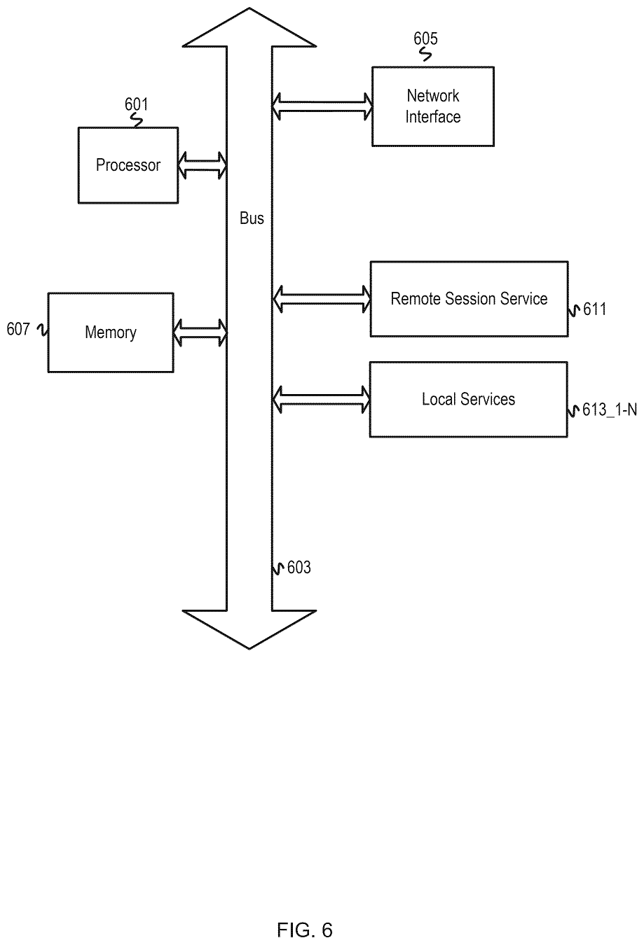

FIG. 6 depicts an example computer system with a remote session service and local services for establishing P2P connections using role-based access policies. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes a remote session service 611 and local services 613_1-N. The remote session service 611 manages RBAC for establishment of remote sessions across endpoints of an organization, wherein the endpoints of the organization have local services 613_1-N installed thereon. When the remote session service 611 receives a request from a local service 613_i for a remote session with an endpoint corresponding to a local service 613_j, the remote session service 611 evaluates roles of endpoints associated with the local service 613_i, 613_j to determine if a remote session is allowed. If a remote session is allowed, the remote session service 611 and local services 613_i, 613_j use ICE to establish a P2P connection. The local services 613_i, 613_j then support remote control and remote session sharing via communication of peripheral input events, session auditing, summary, behavior analysis, content filtering/blocking according to access policies applied to roles of respective endpoints, etc. Although depicted as communicatively coupled to the bus 603, the remote session service 611 and the local services 613_1-N can comprise components of distinct computer systems. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
based on receiving a request to initiate a remote session between a first endpoint and a second endpoint,
determining that the first endpoint is associated with a role that indicates remote access to the second endpoint;
establishing a connection between the first endpoint and the second endpoint;
communicating, from the second endpoint to the first endpoint via the connection, indications of first peripheral input events occurring at the second endpoint; and
simulating the remote session at the first endpoint based, at least in part, on the indications of the first peripheral input events.

2. The method of claim 1, wherein the connection comprises a peer-to-peer connection, wherein establishing the peer-to-peer connection comprises:
exchanging Session Description Protocol (SDP) messages between the first endpoint and the second endpoint; and
negotiating Internet Protocol (IP) address and port pairs at the first endpoint and the second endpoint with Interactive Connectivity Establishment.

3. The method of claim 2,
wherein exchanging the SDP messages comprises exchanging the SDP messages via a WebSocket server, and
wherein negotiating the IP address and port pairs comprises negotiating the IP address and port pairs with at least one of Session Traversal Utilities for Network Address Translation (NAT) servers and Traversal Using Relays around NAT servers.

4. The method of claim 1, further comprising,
based on detecting a request at the first endpoint for remote control of the remote session,
verifying permission for remote control of the remote session based on at least one of notifying the second endpoint of the request for remote control and determining that the role associated with the first endpoint has permissions for remote control;
communicating, from the first endpoint to the second endpoint via the connection, second peripheral events occurring at the first endpoint; and
simulating the second peripheral events as part of the remote session at the second endpoint.

5. The method of claim 1, further comprising, based on determining that the role associated with the first endpoint does not indicate access to the remote session with the second endpoint, blocking the remote session.

6. The method of claim 1, wherein establishing the connection comprises establishing the connection with the Datagram Transport Layer Security protocol.

7. The method of claim 1, further comprising:
monitoring the remote session with a machine learning model; and
based on the monitoring of the remote session, at least one of generating a summary of the remote session with the machine learning model and detecting abnormal or malicious behavior in the remote session with the machine learning model.

8. The method of claim 1, further comprising, based on determining that the role associated with the first endpoint is allowed access to one or more resources, allowing access to the one or more resources in the remote session.

9. The method of claim 1, further comprising blocking access to one or more websites in the remote session according to a security policy associated with the remote session.

10. The method of claim 1, further comprising:
based on determining that the role associated with the first endpoint is not an administrative role, notifying the second endpoint of the remote session prior to initiating the remote session; and
based determining that the role associated with the first endpoint is an administrative role, initiating the remote session without notifying the second endpoint.

11. The method of claim 1, further comprising logging the first peripheral input events during the remote session for incident analysis.

12. A system comprising:
first one or more endpoints running a first service that:
based on a request from a second service running on a first endpoint of a second plurality of endpoints to establish a remote session between the first endpoint and a second endpoint in the second plurality of endpoints, determines whether the remote session is allowed according to an access policy for at least the second plurality of endpoints; and
based on determining that the remote session is allowed, sets up an intermediary to negotiate a connection of the remote session between the first endpoint and the second endpoint; and
the second plurality of endpoints comprising the first endpoint running the second service and the second endpoint running a third service that establish the connection of the remote session via the intermediary, wherein the third service communicates first events of the remote session to the second service, and wherein the second service simulates the remote session at the first endpoint based on the first events.

13. The system of claim 12, wherein the connection comprises a peer-to-peer connection, wherein the first endpoint running the second service and the second endpoint running the third service comprise the first and second endpoints running the second and third services, respectively, that, via the intermediary:
exchange Session Description Protocol (SDP) messages; and
negotiate Internet Protocol (IP) address and port pairs with Interactive Connectivity Establishment (ICE).

14. The system of claim 13, wherein the intermediary comprises a WebSocket server, wherein the first and second endpoints running the second and third services, respectively, that negotiate the IP address and port pairs with ICE comprise the first and second endpoints running the second and third services, respectively, that negotiate the IP address and port pairs with at least one of Session Traversal Utilities for Network Address Translation (NAT) servers and Traversal Using Relays around NAT servers.

15. The system of claim 12, wherein the first one or more endpoints running the first service comprise the first one or more endpoints running the first service that, based on detecting a request at the first endpoint for remote control of the remote session, verifies permission for remote control of the remote session based on at least one of notifying the second endpoint of the request for remote control and determining that a role associated with the first endpoint has permissions for remote control,
wherein the first endpoint running the second service comprises the first endpoint running the second service that communicates second peripheral events occurring at the first endpoint to the second endpoint, and
wherein the second endpoint running the third service comprises the second endpoint running the third service that simulates the second peripheral events as part of the remote session at the second endpoint.

16. The system of claim 12, wherein the first one or more endpoints running the first service comprise the first one or more endpoints running the first service that, based on determining that the role associated with the first endpoint does not indicate access to the remote session with the second endpoint in the access policy, blocks the remote session.

17. One or more non-transitory machine-readable media having program code stored thereon, the program code comprising:
first instructions to:
determine whether a request, from a first endpoint, to establish a remote session between the first endpoint and a second endpoint satisfies an access policy; and
set up an intermediary to negotiate a connection of the remote session between the first endpoint and the second endpoint;
second instructions to, after the remote session between the first endpoint and the second endpoint is established via the intermediary, communicate first events of the remote session from the second endpoint to the first endpoint; and
third instructions to simulate the remote session at the first endpoint based, at least in part, on the first events.

18. The one or more non-transitory machine-readable media of claim 17, wherein the connection comprises a peer-to-peer connection, wherein the second instructions and the third instructions comprise instructions to, via the intermediary:
exchange Session Description Protocol (SDP) messages between the first endpoint and the second endpoint; and
negotiate Internet Protocol (IP) address and port pairs of the first endpoint and the second endpoint with Interactive Connectivity Establishment (ICE).

19. The one or more non-transitory machine-readable media of claim 18, wherein the intermediary comprises a WebSocket server, wherein the second instructions and the third instructions to negotiate the IP address and port pairs with ICE comprise instructions to negotiate the IP address and port pairs with at least one of Session Traversal Utilities for Network Address Translation (NAT) servers and Traversal Using Relays around NAT servers.

20. The one or more non-transitory machine-readable media of claim 17, wherein the first instructions further comprise instructions to, based on detecting a request at the first endpoint for remote control of the remote session, verify permission for remote control of the remote session based on at least one of notifying the second endpoint of the request for remote control and determining that a role associated with the first endpoint has permissions for remote control,
wherein the third instructions further comprise instructions to communicate second peripheral events occurring at the first endpoint to the second endpoint, and
wherein the second instructions further comprise instructions to simulate the second peripheral events as part of the remote session at the second endpoint.
